(19) United States
(12) Patent Application Publication
(10) Pub. No.: US 2016/0140440 A1
(43) Pub. Date: May 19, 2016

(54) REAL-TIME PROACTIVE MACHINE INTELLIGENCE SYSTEM BASED ON USER AUDIOVISUAL FEEDBACK

(71) Applicant: Imageous, Inc., San Jose, CA (US)

(72) Inventors: Jay-Jen Hsueh, San Jose, CA (US); Wen-Hao Tsai, San Jose, CA (US); Yi-I Chiu, San Jose, CA (US); Kuan-Jun Tien, San Jose, CA (US); Zixiang Xuan, San Jose, CA (US)

(21) Appl. No.: 14/943,017

(22) Filed: Nov. 16, 2015

Related U.S. Application Data
(60) Provisional application No. 62/080,209, filed on Nov. 14, 2014.
(60) Provisional application No. 62/080,216, filed on Nov. 14, 2014.

(51) Int. Cl. G06N 5/02; G06N 99/00

(52) U.S. Cl. CPC G06N 5/02; G06N 99/005

(57) ABSTRACT

Disclosed herein are techniques for implementing a machine intelligence computer system that can proactively monitor user audiovisual feedbacks as ques for improving the machine learning and predictive data analytical processes. Based on the real-time feedbacks, the introduced proactive machine intelligence system (PMIS) can dynamically revise (e.g., by assigning different weights) and/or filter the gathered input data for machine learning purposes. The PMIS can also dynamically adjust the machine learning algorithms adapted in the predictive models based on user real-time feedbacks.

### RELATED APPLICATIONS

This application claims the benefit of U.S. Provisional Patent Application No. 62/080,209, entitled “A METHOD FOR IMPROVING THE ACCURACY OF MACHINE-LEARNING PREDICTION AND PROVIDING INSTANT RESPONSIVE ADJUSTMENT,” filed on Nov. 14, 2014; and U.S. Provisional Patent Application No. 62/080,216, entitled “METHOD OF MUSIC RECOMMENDATION BASED ON SURROUNDINGS AND HUMAN EMOTIONS,” filed on Nov. 14, 2014; both of which are incorporated by reference herein in their entireties.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

Embodiments of the present disclosure relate to machine learning and predictive analytics, and more particularly, to a real-time reactive machine intelligence system based on user audiovisual feedbacks.

### BACKGROUND

The fast-growing computer technologies have fueled a large number of technical innovations as well as uncovered countless business opportunities. To stand out in this competitive market, it is crucial for a business to be user machine intelligence technologies to be more efficient. Techniques such as machine prediction, process automation, and so forth, are all examples of the attempts that have been made for making the business more efficient.

However, conventional machine learning and data processing techniques are limited to historical data and, perhaps more importantly, reactive in nature. In particular, the prediction model are readjusted only when the prediction misses the target, for example, after similar mistakes are made when predicting for different users. This reactive nature of conventional techniques leads to misleading results and lower accuracy of prediction. Moreover, conventional techniques usually require additional integration and customization, which not only increases the difficulty of product development but also increases the cost of maintenance.

### BRIEF DESCRIPTION OF THE DRAWINGS

The present embodiments are illustrated by way of example and are not intended to be limited by the figures of the accompanying drawings. The same reference numbers and any acronyms identify elements or acts with the same or similar structure or functionality throughout the drawings and specification for ease of understanding and convenience.

FIG. 1A illustrates an example environment within which the proactive machine intelligence system (PMIS) introduced here can be implemented.

FIG. 1B illustrates another example environment within which the PMIS introduced here can be implemented.

FIG. 2 illustrates a diagram that shows additional details of the PMIS as well as an overall communications flow adopted by the PMIS in FIGS. 1A-1B.

FIG. 3 illustrates an example configuration diagram that can be implemented by the PMIS for improving machine learning accuracy with real-time response adjustment.

FIGS. 4A-4B illustrate details of an example method that can be implemented by the PMIS for calculating confidence levels.

FIG. 5 illustrates a user input interface of an example project management application implemented using the PMIS introduced here.

FIG. 6 illustrates another user input interface of the example project management application of FIG. 5.

FIG. 7 illustrates yet another user input interface of the example project management application of FIG. 5.

FIG. 8 illustrates an example result user interface of the example project management application of FIG. 5.

FIG. 9 illustrates an example of the user audiovisual feedback information stored in the database of the PMIS that can be used for proactively improving the PMIS's prediction accuracy.

FIG. 10 illustrates an example of the PMIS providing music recommendation based on surroundings and human emotions.

FIG. 11 illustrates details of a visual data extraction process that may be adopted by the PMIS.

FIG. 12 illustrates details of a training phase of an audio data extraction process that may be adopted by the PMIS.

FIG. 13 illustrates details of an application phase of the audio data extraction process of FIG. 12.

FIG. 14 illustrates an example interface of an application that utilizes the PMIS (e.g., via an application programming interface) for music recommendation based on instant audiovisual feedbacks.

FIG. 15 illustrates an example interface of the application of FIG. 14 showing image data extraction and analysis results.

FIG. 16 illustrates an example interface of the application of FIG. 14 showing music recommendation.

FIG. 17 illustrates a high-level block diagram showing an example of processing system in which at least some operations related to the generation of the disclosed quick legend receipt(s) can be implemented.

### DETAILED DESCRIPTION

Various examples of the present disclosure are now described. The following description provides specific details for a thorough understanding and enabling description of these examples. One skilled in the relevant art will understand, however, that the embodiments disclosed herein may be practiced without many of these details. Likewise, one skilled in the relevant art will also understand that the present embodiments may include many other obvious features not described in detail herein. Additionally, some well-known methods, procedures, structures or functions may not be shown or described in detail below, so as to avoid unnecessarily obscuring the relevant description.

The techniques disclosed below are to be interpreted in their broadest reasonable manner, even though they are being used in conjunction with a detailed description of certain specific examples of the present disclosure. Indeed, certain terms may even be emphasized below; however, any terminology intended to be interpreted in any restricted manner will be overtly and specifically defined as such in this Detailed Description section.

References in this description to “an embodiment,” “one embodiment,” or the like, mean that the particular feature, function, structure or characteristic being described is included in at least one embodiment of the present invention. Occurrences of such phrases in this specification do not necessarily all refer to the same embodiment. On the other hand, the embodiments referred to also are not necessarily mutually exclusive. Each of the modules and applications described herein may correspond to a set of instructions for performing one or more functions described above and the methods described in this application (e.g., the computer-implemented methods and other information processing methods described herein). These modules (e.g., sets of instructions) need not be implemented as separate software programs, procedures or modules, and thus various subsets of these modules may be combined or otherwise rearranged (e.g., from the server side to the client side) in various embodiments.

It is observed that the reactive nature of conventional techniques leads to misleading results and lower accuracy of prediction. Moreover, conventional techniques usually require complex system architecture, which not only increases the difficulty of product development but also increases the cost of maintenance. Further, conventional machine learning and data processing techniques are limited to historical data and, perhaps more importantly, reactive in nature.

Accordingly, disclosed herein are techniques for implementing a machine intelligence computer system that can proactively monitor user audiovisual feedbacks as ques for improving the machine learning and predictive data analytical processes. Based on the real-time feedbacks, the introduced proactive machine intelligence system (PMIS) can dynamically revise (e.g., by assigning different weights) and/or filter the gathered input data for machine learning purposes. The PMIS can also dynamically adjust the machine learning algorithms adapted in the predictive models based on user real-time feedbacks.

Various aspects of the PMIS as well as several example use cases of the PMIS are introduced in more detail below. In the ways introduced here, the PMIS is highly adaptable to a wide variety of applications. The PMIS also has higher accuracy than conventional approaches, resulting in better prediction results and more relevant recommendations.

### System Overview

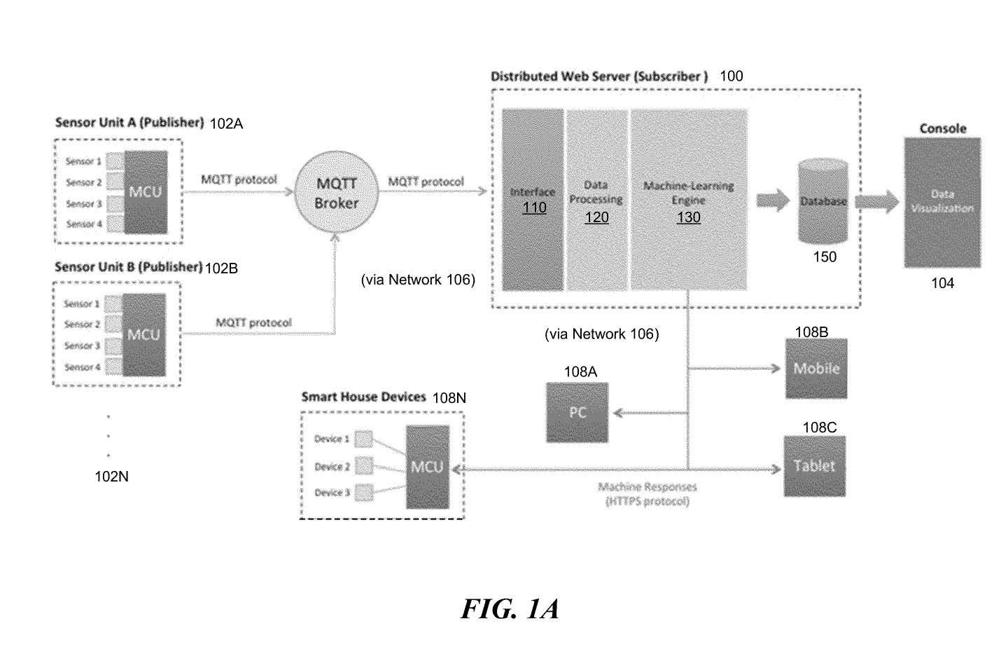

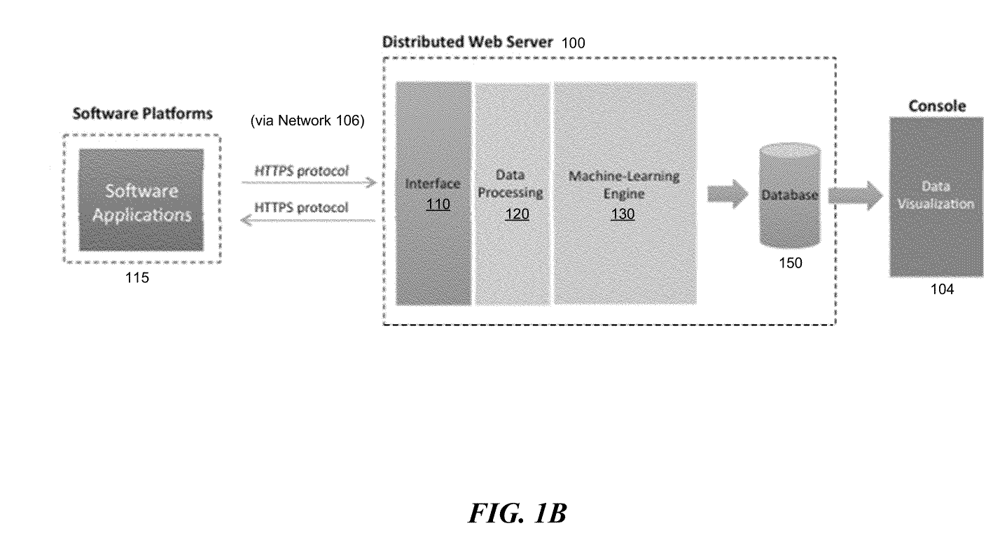

FIG. 1A illustrates an example internet of things (IoT) environment within which the proactive machine intelligence system (PMIS) introduced here can be implemented. The environment includes a host server 100 that operates the PMIS platform that provides rapid and dynamic predictive analytics adjustment based on proactively monitoring user feedbacks (e.g., a captured image, a recorded sound clip, or a video feed). In one or more implementations, the PMIS platform is connected to a network 106 (shown as background in FIG. 1A) or across networks to communicate data to and from various input client devices 102A-N as well as output client devices 108A-N. In some embodiments, the host server 100 is implemented using a cloud-based server service.

The PMIS platform can be accessed through a variety of methods. For example, in some embodiments, the PMIS platform can receive data (e.g., sensor readouts such as image, sound, ambient temperature, etc.) from the users via input client devices 102A-N. In addition or as an alternative to passively receiving the data, the PMIS platform may also employ suitable mechanisms to actively download, pull, or crawl the data from the users. The client devices 102A-N and 108A-N can be any system and/or device, and/or any combination of devices/systems that are able to establish a connection with another device, a server and/or other systems. Client devices 102A-N each typically include a display and/or other output functionalities to present information and data exchanged between among the devices 102A-N, devices 108A-N and the host server 100. The client devices 102A-N and 108A-N can be provided with user interfaces 104 for accessing data processed and/or any results produced by the platform. For example, data received and processed by the PMIS can be viewed in a webpage interface that is hosted by the host server 100.

Examples of the client devices 102A-N and 108A-N can include computing devices such as mobile or portable devices or non-portable devices. Non-portable devices can include a desktop computer, a computer server or cluster. Portable devices can including a laptop computer, a mobile phone, a smart phone, a personal digital assistant (PDA), a handheld tablet computer. Typical input mechanism on client devices 102A-N and/or 108A-N can include a touch screen display (including a single-touch (e.g., resistive) type or a multi-touch (e.g., capacitive) type), gesture control sensors, a physical keypad, a mouse, motion detectors (e.g., accelerometer), light sensors, temperature sensor, proximity sensor, device orientation detector (e.g., compass, gyroscope, or GPS), and so forth.

In implementing and maintaining the PMIS platform, the host server 100 may be communicatively coupled to one or more repositories 124 that store raw or processed data. The repository 150 may be physically connected to the host server 100 or can be remotely accessible through the network 106. More specifically, the host server 100 may include internally or be externally coupled to the repository 150. The repository 150 (which may be comprised of several repositories) can store software, descriptive data, images, system information, drivers, and/or any other data item utilized by other components of the host server 100 and/or any other servers for operation. The repositories may be managed by a database management system (DBMS) including, for example, MySQL, SQL Server, Oracle, and so forth. In variations, the repository 150 can be implemented and managed by a distributed database management system, an object-oriented database management system (OODBMS), an object-relational database management system (ORDBMS), a file system, a NoSQL or other non-relational database system, and/or any other suitable database management package.

The network 106 can be any collection of distinct networks operating wholly or partially in conjunction to provide connectivity to the client devices 102A-N and 108A-N, the host server 100, and other suitable components in FIG. 1, which may appear as one or more networks to the serviced systems and devices. In one embodiment, communications to and from the client devices 102A-N and 108A-N can be achieved by an open network, such as the Internet, or a private network, such as an intranet and/or the extranet. For example, the Internet can provide file transfer, remote log in, email, news, RSS, cloud-based services, instant messaging, visual voicemail, push mail, VoIP, and other services through any known or convenient protocol, such as, but is not limited to, the TCP/IP protocol, Open System Interconnection (OSI) protocols, and so forth. In one embodiment, communications can be achieved by a secure communications protocol, such as secure sockets layer (SSL), or transport layer security (TLS).

The client devices 102A-N and 108A-N, the host server 100, and the repository 150 can be communicatively coupled to each other through the network 106 and/or multiple networks. In some embodiments, the devices 102A-N, the devices 108A-N, and the host server 100 may be directly connected to one another. In some embodiments, one or more of the devices 102A-N and devices 108A-N may be the same devices.

In addition, communications can be achieved via one or more wired or wireless networks including, for example, a Local Area Network (LAN), Wireless Local Area Network (WLAN), a Wide Area Network (WAN). These networks can be enabled with communications technologies such as Global System for Mobile Communications (GSM), Personal Communications Service (PCS), Bluetooth, Wi-Fi, 2G, 3G, LTE Advanced, WiMax, etc., and with messaging protocols such as Ethernet, SMS, MMS, real time messaging protocol (RTMP), IRC, or any other suitable data networks or messaging protocols.

FIG. 1B illustrates an example software application environment within which the PMIS introduced here can be implemented. In the embodiments shown in FIG. 1B, a software application 115 (e.g., a conventional desktop software application or a mobile application (“app”)) can run on the client devices 102A-N and 108A-N. The application 115 can provide the same or similar interface as interfaces 104. In this variation, the functionalities of the platform can be provided from the host server 100 to the users through the applications 115 (which may be an application from a third-party vendor) (e.g., through the use of an application programming interface (API)).

Note that the software as a service (SAAS) environment illustrated in FIGS. 1A and 1B are merely two examples. Additionally or alternatively, in one or more implementations, the PMIS platform introduced here can be fully or at least partially installed at the user's site; in such cases, the PMIS platform need not receive the readouts over a large area network (e.g., the Internet). In some examples, the client devices 102A-N provide data to the PMIS platform in the form of batch processes, even though in preferred embodiments the data is provided in a real-time or near real-time manner.

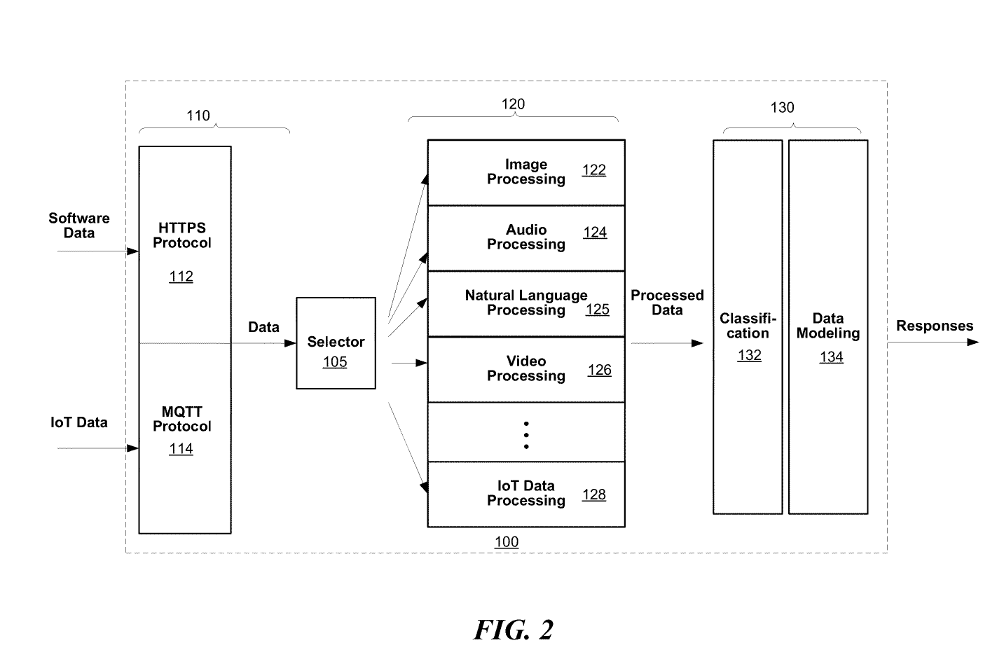

FIG. 2 illustrates a diagram that shows additional details of the PMIS as well as an overall communications flow adopted by the PMIS in FIGS. 1A-1B. The input data can be sent by, for example, HTTPS and MQTT protocol. Although the PMIS can adopt any suitable communications protocol, it is preferable that the communications protocol adopted by the PMIS can provide the flexibility of integration with the particular application (e.g., internet of things (IoT) application (FIG. 1A) or software application (FIG. 1B)). The PMIS receives the raw data (e.g., readouts from various sensors in input client devices 102A-N) at an interface layer 110, the raw data is sent to a selector 105. The selector 105 can detect the format of the raw data and chose the proper functional block in a data processing layer 120 to process the data. After the data processing, the processed data is in a compatible format for performing machine-learning activities by a machine learning engine layer 130. By the machine learning layer 130, processed data then is classified by different classifiers, and then modeled into machine responses.

As used herein, a “module,” a “manager,” an “agent,” a “tracker,” a “handler,” a “detector,” an “interface,” or an “engine” includes a general purpose, dedicated or shared processor and, typically, firmware or software modules that are executed by the processor. Depending upon implementation-specific or other considerations, the module, manager, tracker, agent, handler, or engine can be centralized or its functionality distributed. The module, manager, tracker, agent, handler, or engine can include general or special purpose hardware, firmware, or software embodied in a computer-readable (storage) medium for execution by the processor.

As illustrated in the example of FIG. 2, the interface layer 110 may implement an HTTPS protocol module 112 for receiving data from software applications (e.g., via API). Additionally or alternatively, the interface layer 110 may implement an MQTT protocol module 114 for receiving data from IoT devices. More specifically, the interface layer 110 implements the communication protocols for the PMIS to communication with other software platforms and/or IoT devices. The interface layer 110 improves the usability of the PMIS by being modular and expandable. In some examples, in order to communicate with IoT devices and software platforms, MQTT and HTTPS protocols can be used. The MQTT protocol is a preferred protocol for IoT communication because of its low-power feature and low bandwidth data transmission. The HTTPS protocol can used for connecting software platforms for its high popularity and security.

The data processing layer 120 may implement a number of processing modules including, for example, an image processing module 122, an audio processing module 124, a natural language processing module 125, a video processing module 126, and/or an IoT data reformation module 128.

The machine learning layer 130 may implement a classification module 132, and a data modeling module 134. Specifically, the machine learning layer 130 is used by the PMIS for performing machine prediction based on proactively monitoring real-time user feedbacks. In some implementations, the machine learning layer 130 performs data clustering and data classification by using the classification module 132, and data modeling by using the data modeling module 134. As compared with conventional machine intelligence systems, the PMIS introduced here has fully integrated functionalities that provide a universal solution for a wide variety of applications.

With continued reference to FIGS. 1A, 1B, and 2, various techniques that may be implemented by the PMIS for providing the functionalities introduced here is now described with the following use cases. The use cases introduced here demonstrate how the PMIS introduced here improves the usability of machine intelligence.

### Improvement on Machine-Learning Prediction Accuracy and Instant Response Adjustment Based on Proactive User Monitoring

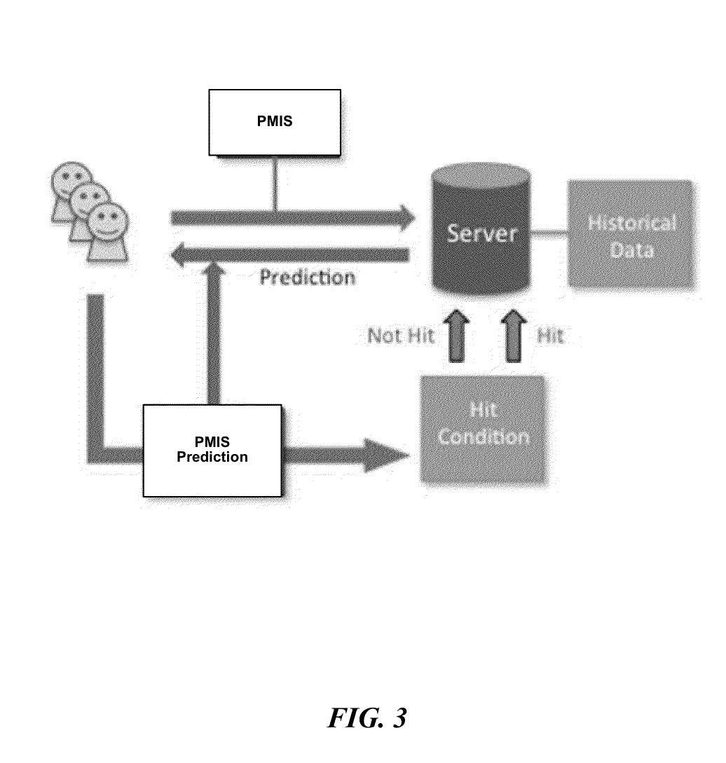

FIG. 3 illustrates an example configuration diagram that can be implemented by the PMIS for improving machine learning accuracy with real-time response adjustment. As discussed above, the PMIS can be a platform for evaluating confidence level by facial expression, and in some scenarios, the PMIS can also send the request to another service provider's server for adjusting a response or any relevant data that is deemed appropriate or necessary based on developers' definition. For example, as illustrated in FIG. 3, a “hit condition block” is used by the PMIS for setting up the thresholds of confidence level. In some implementations, once the confidence level is below threshold, it can trigger the PMIS to adjust server responses.

More specifically, as previously discussed, conventional machine learning structures can only predict user behaviors based on historical data, that is, in a reactive manner. One major drawback of those conventional techniques is that the prediction model can only be readjusted when the prediction misses the target or after similar mistakes are made by different users. For instance, when a user fills in a sign-up form, the user may be uncertain about some of the information, such as more ambiguous questions like interests, hobbies, and so forth. The uncertainty can lead to information that is not only misleading (and adversely affecting machine learning's results), but also lowering the accuracy of prediction.

The embodiments of the PMIS introduced here resolves or mitigate this problem by proactively reading human reactions and making instant adjustment to the prediction results as well as the inputs for the machine learning models. More specifically, the PMIS can be utilized to enhance the accuracy of machine learning prediction by “reading the body language of the user.” In one or more embodiments, every time when the user types in a piece of information, the PMIS can automatically start capturing (e.g., via the application 115) the face images of the user and uploading the images simultaneously to the PMIS. These images are then analyzed by the PMIS by comparing with reference images to measure the probabilities. Thereafter, the probabilities are convert to a score, which represents the “confidence level” of the users. The higher the score is, the more confident the user is about the data.

At least some implementations provide that, by the time the user finishes filling out the information, the PMIS can also generate the score showing how confident the user is about the input data. Further in some embodiments, when the PMIS detects a below-threshold score, the PMIS can automatically adjust the prediction for the user's need before generating recommendation, suggestion, or any relevant data to the user. In this way, the PMIS brings improvement over conventional techniques in that the PMIS not only reads historical data for any predictive analysis, but also measures human reactions to make instant adjustment.

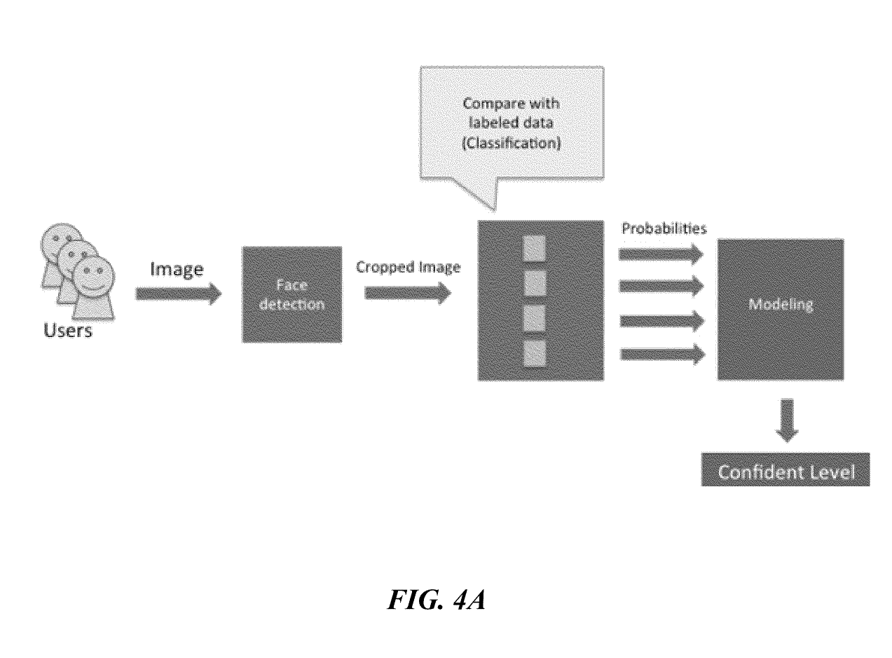

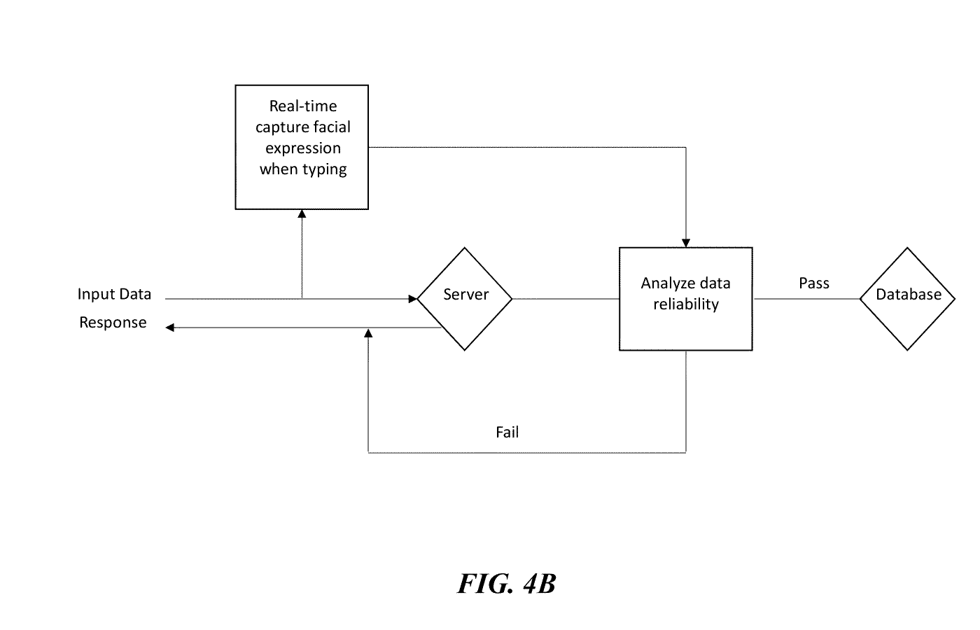

FIGS. 4A-4B illustrate details of an example method that can be implemented by the PMIS for calculating confidence levels.

The flowchart of the above use case of FIG. 3 is shown in FIG. 4B. When the data is uploaded to the server, the PMIS can continuously capture facial expression. The expression data is then used to identify the reliability of the input data from the user. If the data's confidence level passes the predetermined criteria, then the data is considered as reliable and can be stored in database. Otherwise, the data can be filtered out or given a less weight, and the machine responses can be adjusted accordingly.

In the flow chart of FIG. 4A, first, when captured images are uploaded, the images go into a face detection block in the server 100 (e.g., image processing module 122) to crop faces appear on the images. The cropped images are then sent to classification block (e.g., module 132) to map the confidence level. The data modeling formula can derived from training data and stored in the repository 150.

In some implementations, the PMIS can be implemented in conjunction with a project management software for implementing a portion of the software. For example, the PMIS can be utilized to recommend customized solution to users. Specifically, in some embodiments, when users answer the questions on the project management software, the PMIS automatically captures the facial expressions. After the image data is transferred to the PMIS server, the result from the PMIS can help the project management software make a first-pass confidence level judgment before sending a suggested solution to the users. In this regard, the additional feature provided by the PMIS functions like the eyes of the machine to mimic a real life consulting service with human representatives.

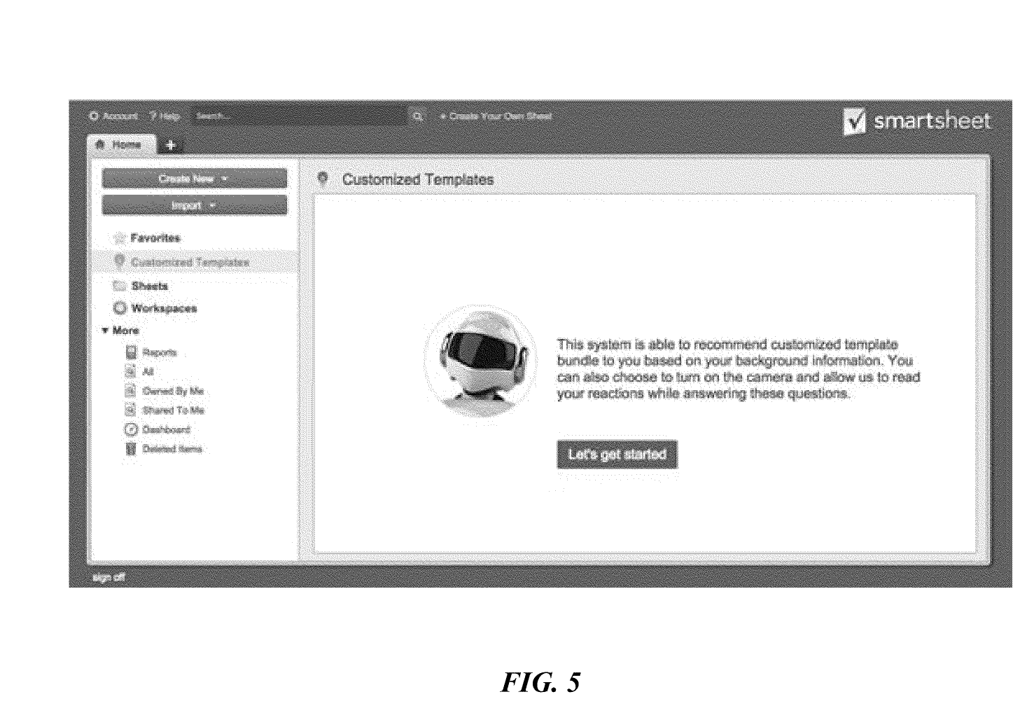

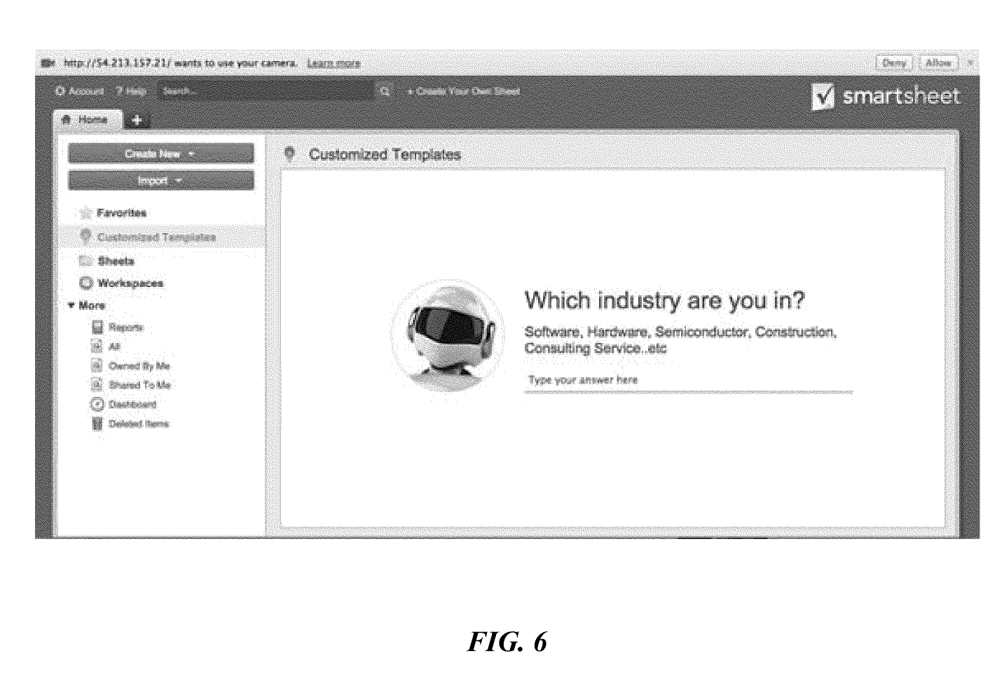

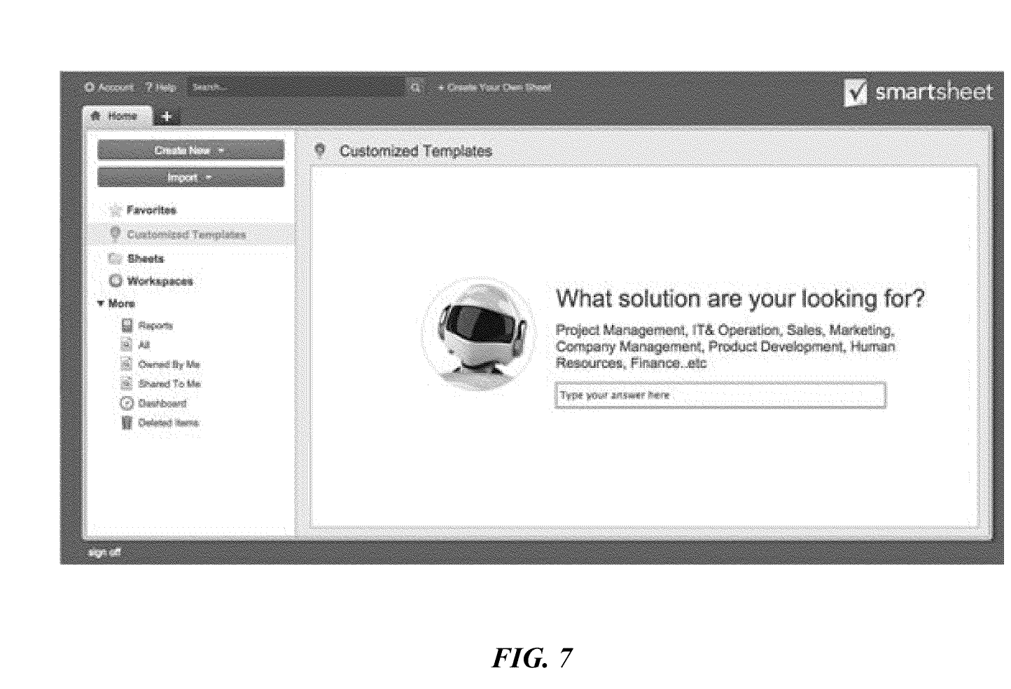

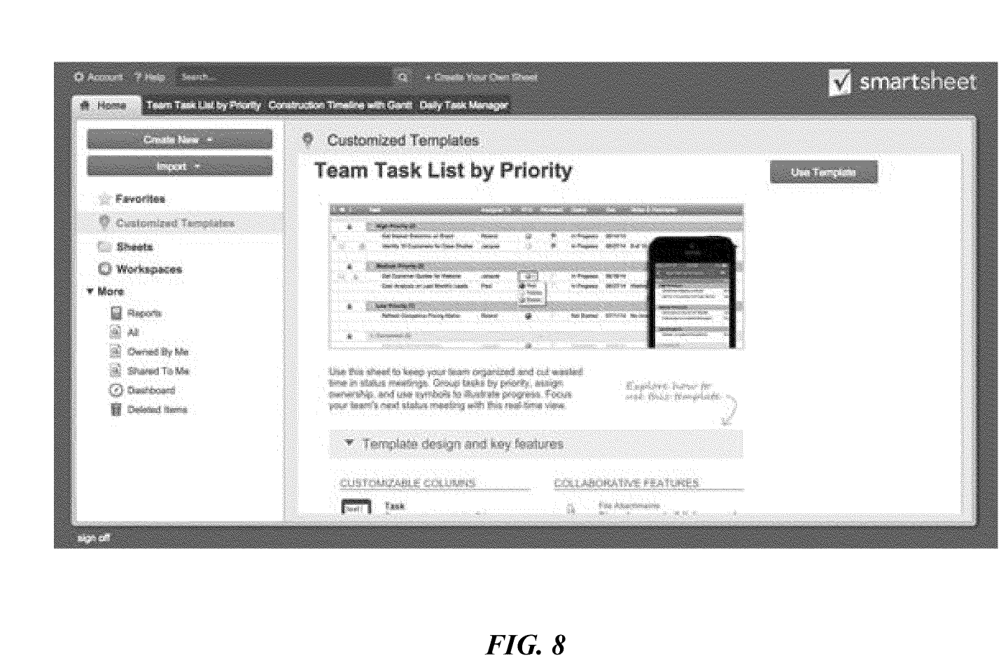

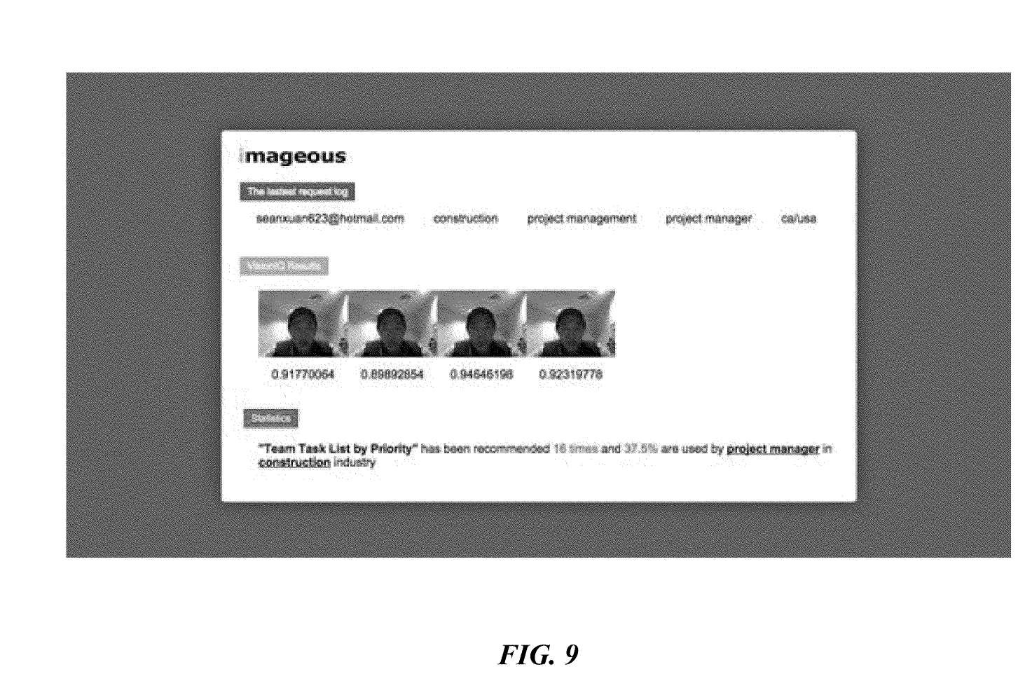

FIGS. 5-8 illustrates a user input interface of an example project management application implemented using the PMIS introduced above. For example, users can get customized solution simply by answering several questions, e.g., FIG. 6 (which industry are you in), FIG. 7 (what solution are you looking for), and FIG. 8 shows the result of machine recommendation. As shown in FIGS. 5-8, a set of templates can be provided according to each different customers and their reactions. FIG. 9 illustrates an example of the user audiovisual feedback information stored in the database of the PMIS that can be used for proactively improving the PMIS's prediction accuracy.

In the above described manner, the present disclosure combines the benefit of conventional machine learning mechanisms and existed data mining classification, but with a major improvement over existing techniques by adding an instant response and adjustment mechanism. In addition, customized data modeling mechanism can be implemented by the PMIS to measure confidence level.

### Music Recommendation Based on Surroundings and Human Emotions

Current music recommendation is derived from user logs and historical data. The problem of conventional recommendation mechanisms is that they always recommend similar content to the users. However, in the real world, human emotion and the surroundings usually highly affect the preferences of the music the users want to listen. Accordingly, in some embodiments, the PMIS can be configured to measure the surroundings and human emotions, and make music recommendations accordingly. Further, in some embodiments, the PMIS can implement a different the output format than the conventional expression detection techniques. The PMIS may not generate labeled results, and instead, can output a modeled parameter to match with music data.

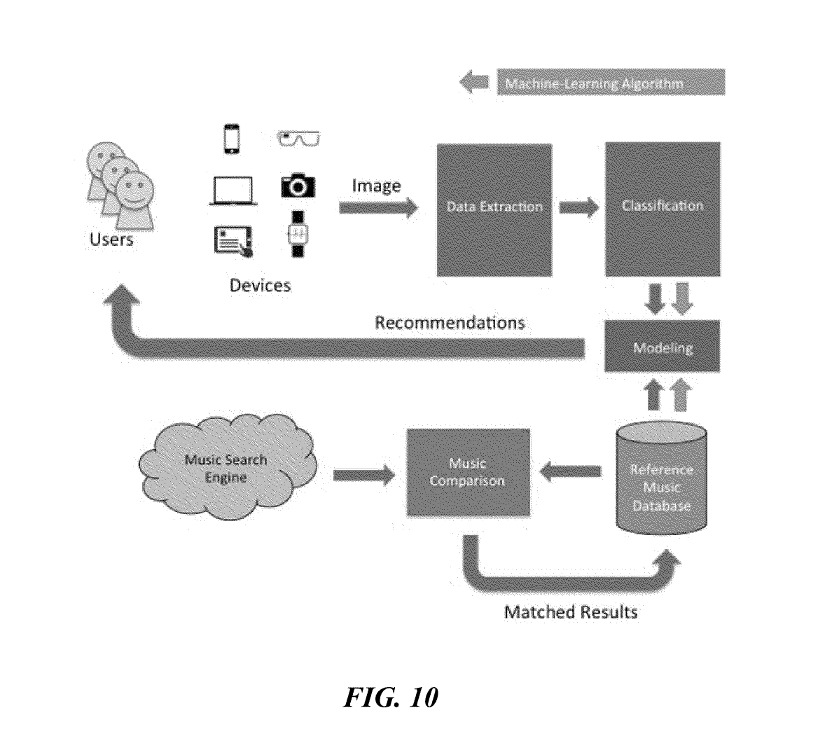

FIG. 10 illustrates an example of the PMIS providing music recommendation based on surroundings and human emotions. In the system diagram of FIG. 10, the images are first uploaded by users, which are sent to the PMIS server to process data extraction. The data from the images is extracted and analyzed to provide the information of human emotion and the occasions. In order to match the audio data, human emotion can be modeled to a single parameter and so does audio information.

The method introduced here can recommend the music based on human emotions, surroundings and historical data. This music recommendation functionality provides a new way to include the data from human beings and surroundings into the computation. This technique can be categorized into two sections. One is image data analysis, and the other is audio data analysis.

First, the images is captured by the devices and uploaded to the server. The images files then go through a first analysis to see if there is any face that can be identified. After the facial detection, the images then are be separated into two parts. One is a front scene, and the other is the background of the image. The PMIS can extract the color features and luminosity of these two parts. If a face is detected, the PMIS then runs another analysis to model the expression into a parameter. Similar techniques can be implemented in the audio analysis section. When the music is sent to the server, the audio data can be extracted and stored in the database. These audio data can be used to model another parameter to match image data. In certain embodiments, around 300 audio data samples are stored initially in training phase. During the training phase, the audio data can be adjusted according to the machine learning results. Through this process, which may be performed iteratively for a predetermined period of time, the modeled results (i.e., parameters) then become more accurate. In some embodiments, these training data is defined as “labeled data” (i.e., references).

When this mechanism reaches to an application phase, new input music can be compared by the PMIS with the labeled data to find any similarity. In some embodiments, the PMIS can determine that which audio data is more or the most similar to the new input.

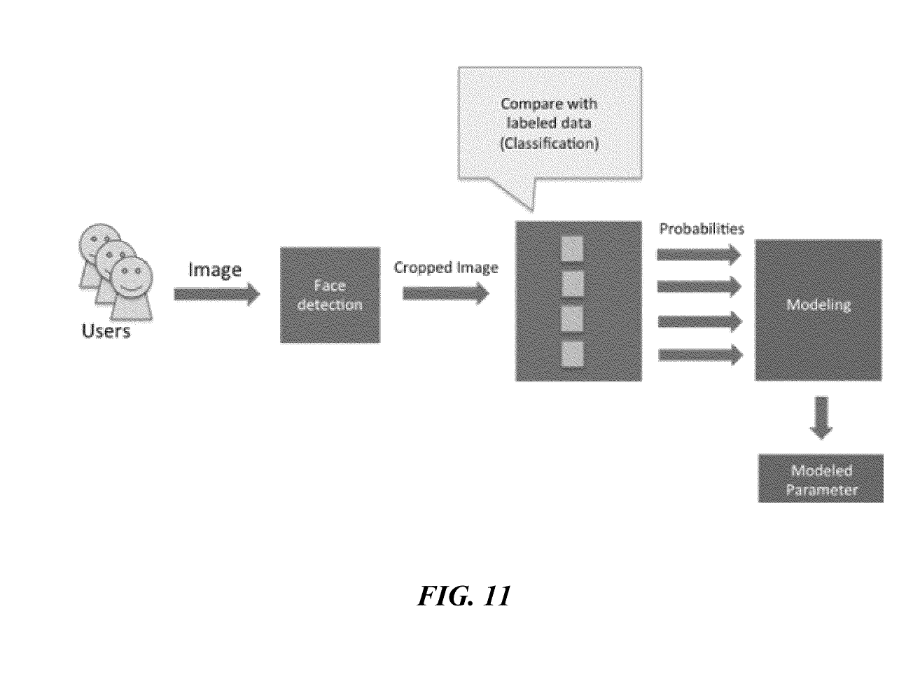

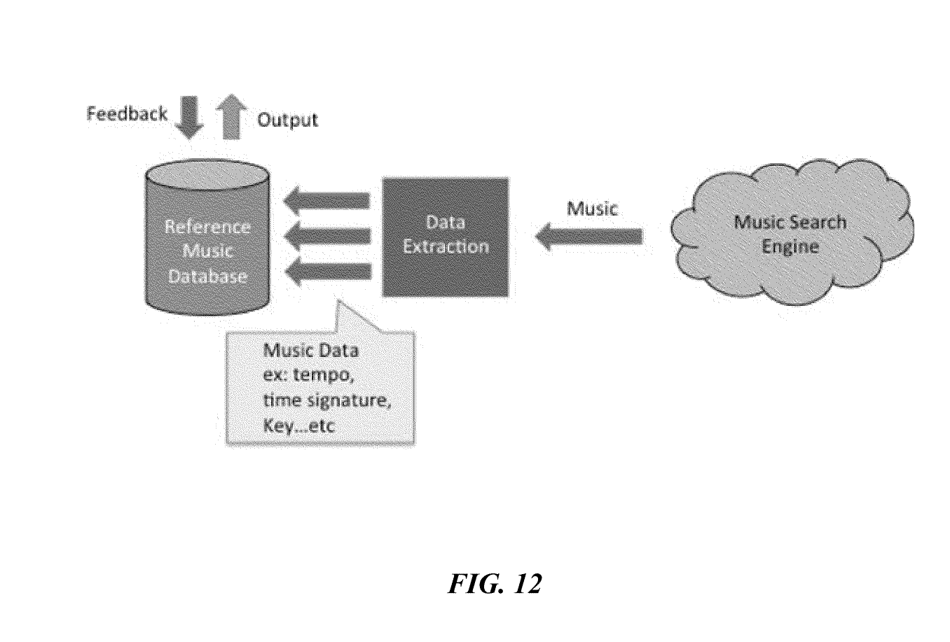

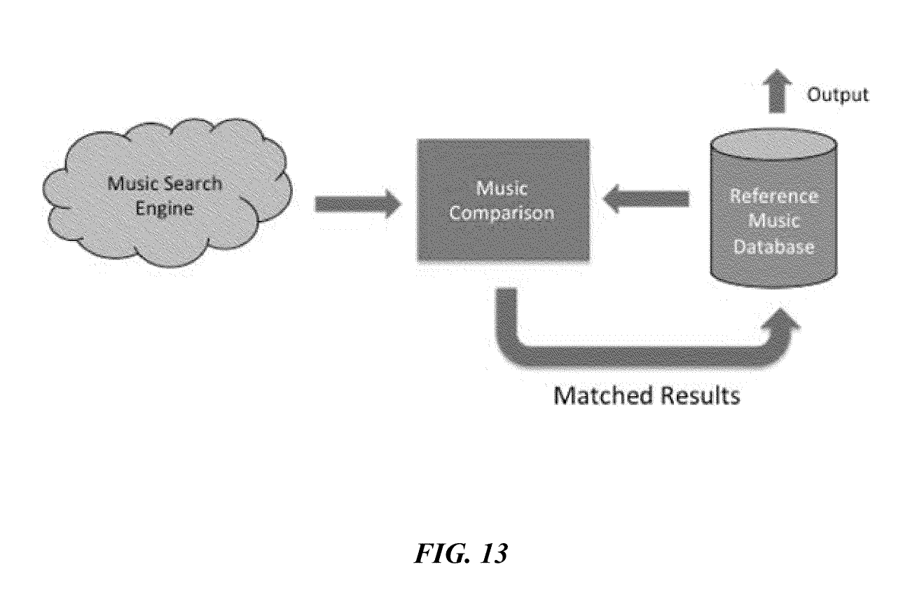

FIG. 11 illustrates details of a visual data extraction process that may be adopted by the PMIS. The face detection technique can be utilized to determine whether there is any human being in the image. The input image is then cropped and separated into two images. One is face image, and the other is background images. The color features, lightness and luminosity of those images can then be analyzed to determine the possible occasion of the input images. Then, the face image can be sent to the classification procedure, which outputs possibilities of different degree of emotion. These numbers are then modeled to a parameter for data matching. FIG. 12 illustrates details of a training phase of an audio data extraction process that may be adopted by the PMIS. Similar techniques to visual data can be utilized for audio data extraction. When the music is pulled in by a music search engine (e.g., Shazam™), the audio data can be extracted, such as tempos, melody signatures and keys. These pieces of data can used by the PMIS to perform data modeling. The initial audio data should be trained by users, then the trained data can be defined as labeled data (i.e., reference). FIG. 13 illustrates details of an application phase of the audio data extraction process of FIG. 12. During the application phase, the music data from music engine then can skip the procedure of data extraction and data training. Instead, the data is compared with references and is further stored in database directly. This can reduce the data processing time. In addition, this can reduce the duration of additional training phases.

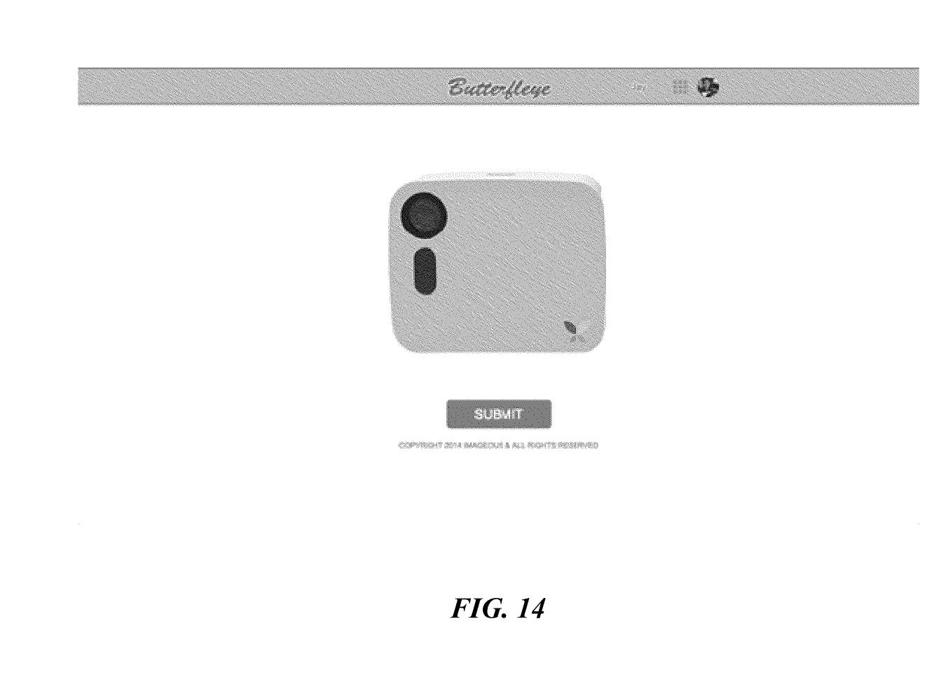

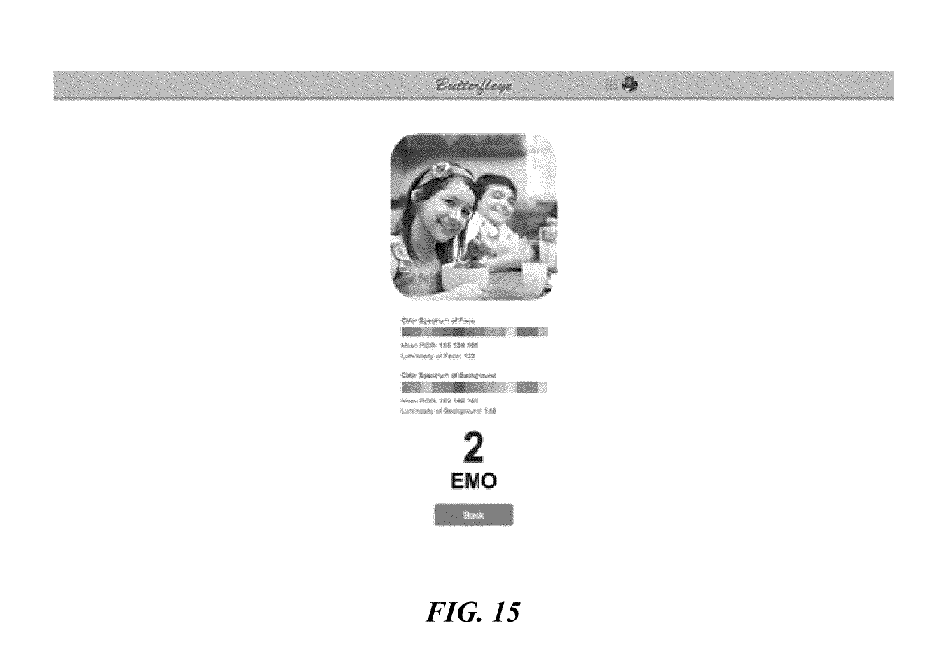

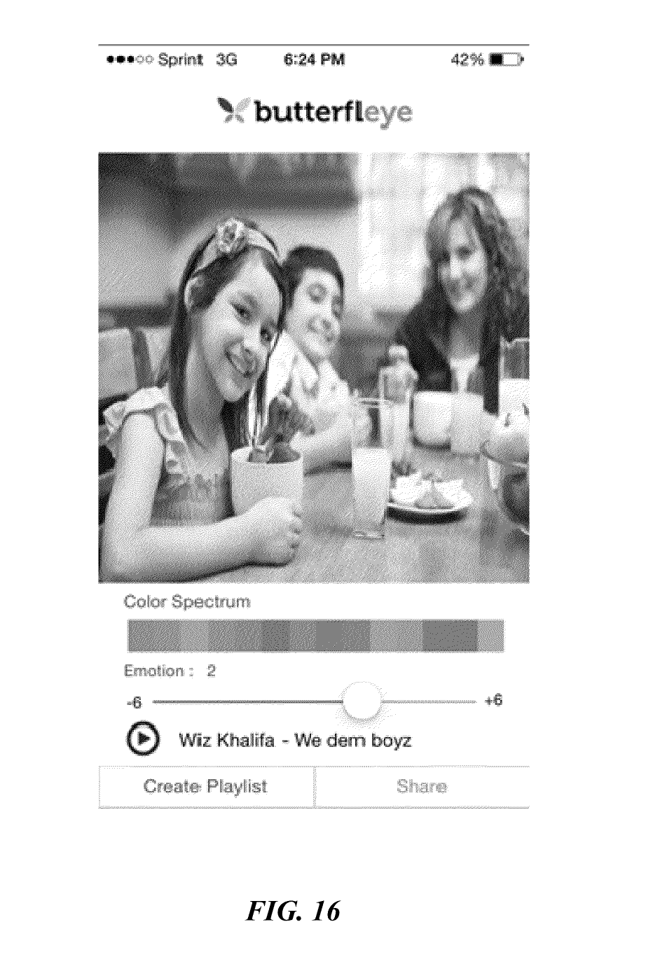

FIG. 14 illustrates an example interface of an application that utilizes the PMIS (e.g., via an application programming interface) for music recommendation based on instant audiovisual feedbacks. FIG. 15 illustrates an example interface of the application of FIG. 14 showing image data extraction and analysis results. FIG. 16 illustrates an example interface of the application of FIG. 14 showing music recommendation.

FIGS. 14-16 illustrate a scenario where a user comes back home from the office. The user opens the door and feels tired after a long day. Then, the PMIS enables a music player to automatically turn on the music. It is jazz music, which is recommended by the PMIS according to the user's emotion, the atmosphere, the light, the ambient temperature, as well as the time of the day. Similar applications can be implemented in a car, a coffee shop, or a department store.

In this way, this technique combines image processing, audio processing and data mining. Note that, the modeling methodology adopted by the PMIS here uses a single parameter, which may be preferable because such single parameter increases the compatibility of this technique in various fields, thereby capable of providing customized solutions.

Note that, while the system generally provides the automatic music and/or content recommendation to the users through mobile devices in the embodiments emphasized herein, in other embodiments the users may use a computing device other than a mobile device to specify that information, such as a conventional personal computer (PC). In such embodiments, the mobile personalization application can be replaced by a more conventional software application in such computing device, where such software application has functionality similar to that of the mobile personalization application as described herein.

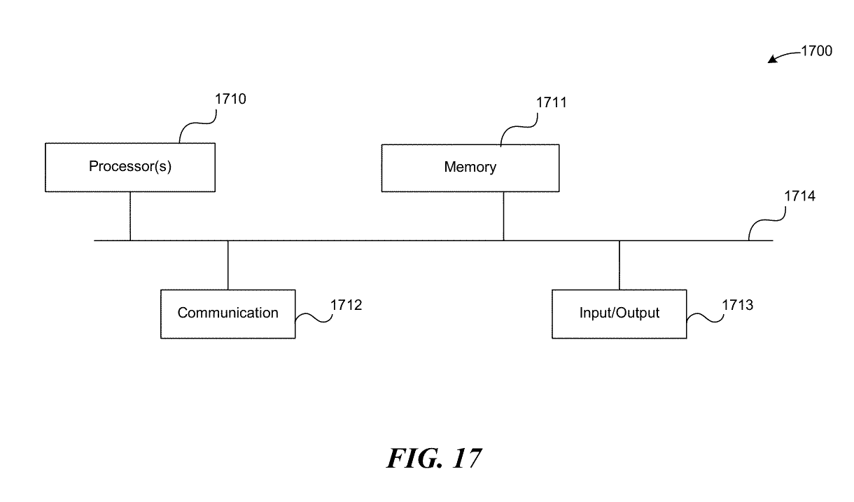

FIG. 17 is a high-level block diagram showing an example of a processing device 1700 that can represent any of the devices described above, such as the mobile devices 102, 108 or the PMIS 100. As noted above, any of these systems may include two or more processing devices such as represented in FIG. 17, which may be coupled to each other via a network or multiple networks.

In the illustrated embodiment, the processing system 1700 includes one or more processors 1710, memory 1711, a communication device 1712, and one or more input/output (I/O) devices 1713, all coupled to each other through an interconnect 1714. The interconnect 1714 may be or include one or more conductive traces, buses, point-to-point connections, controllers, adapters and/or other conventional connection devices. The processor(s) 1710 may be or include, for example, one or more general-purpose programmable microprocessors, microcontrollers, application specific integrated circuits (ASICs), programmable gate arrays, or the like, or a combination of such devices. The processor(s) 1710 control the overall operation of the processing device 1700. Memory 1711 may be or include one or more physical storage devices, which may be in the form of random access memory (RAM), read-only memory (ROM) (which may be erasable and programmable), flash memory, miniature hard disk drive, or other suitable type of storage device, or a combination of such devices. Memory 1711 may store data and instructions that configure the processor(s) 1710 to execute operations in accordance with the techniques described above. The communication device 1712 may be or include, for example, an Ethernet adapter, cable modem, Wi-Fi adapter, cellular transceiver, Bluetooth transceiver, or the like, or a combination thereof. Depending on the specific nature and purpose of the processing device 1700, the I/O devices 1713 can include devices such as a display (which may be a touch screen display), audio speaker, keyboard, mouse or other pointing device, microphone, camera, etc.

### CONCLUSION

Unless contrary to physical possibility, it is envisioned that (i) the methods/steps described above may be performed in any sequence and/or in any combination, and that (ii) the components of respective embodiments may be combined in any manner.

The techniques introduced above can be implemented by programmable circuitry programmed/configured by software and/or firmware, or entirely by special-purpose circuitry, or by a combination of such forms. Such special-purpose circuitry (if any) can be in the form of, for example, one or more application-specific integrated circuits (ASICs), programmable logic devices (PLDs), field-programmable gate arrays (FPGAs), etc.

Software or firmware to implement the techniques introduced here may be stored on a machine-readable storage medium and may be executed by one or more general-purpose or special-purpose programmable microprocessors. A “machine-readable medium”, as the term is used herein, includes any mechanism that can store information in a form accessible by a machine (a machine may be, for example, a computer, network device, cellular phone, personal digital assistant (PDA), manufacturing tool, any device with one or more processors, etc.). For example, a machine-accessible medium can include recordable/non-recordable media (e.g., read-only memory (ROM), random access memory (RAM), magnetic disk storage media, optical storage media, flash memory devices, etc.).

Note that any and all of the embodiments described above can be combined with each other, except to the extent that it may be stated otherwise above or to the extent that any such embodiments might be mutually exclusive in function and/or structure.

Although the present disclosure has been described with reference to specific exemplary embodiments, it will be recognized that the techniques introduced here are not limited to the embodiments described. Accordingly, the specification and drawings are to be regarded in an illustrative sense rather than a restrictive sense.

What is claimed is:

1. A method for improving prediction accuracy in a machine learning system, the method comprising:
receiving textual input data from a user;
without receiving additional input from the user, continuously monitoring additional user audiovisual feedbacks from the user, wherein the additional user feedbacks include at least one of: a visual data of the user, or an audio data of the user;
in response to receiving the additional user audiovisual feedbacks, performing an analysis on the additional user audiovisual feedbacks to determine a confidence level of the user for the textual input data;
adjusting a weight assigned to the textual input data based on the confidence level of the user for the textual input data; and
inputting the textual input data along with its adjusted weight into a machine learning data model.
